(19) United States
(12) Patent Application Publication
(10) Pub. No.: US 2008/0025816 A1
(43) Pub. Date: Jan. 31, 2008

(54) Multiple-thread screw

(75) Inventors: Ming-Shing Chen, Kaohsiung Hsien (TW); Pau-Ten Lin, Kaohsiung Hsien (TW)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Jau Yeou Industry Co., Ltd., Kaohsiung Hsien (TW)

(21) Appl. No.: 11/495,969

(22) Filed: Jul. 28, 2006

(51) Int. Cl. F16B 25/10

(52) U.S. Cl. 411/387.1

(57) ABSTRACT

A multiple-thread screw includes: a shank having a tapered end portion and a non-tapered portion, the shank defining an axis and a radial plane radiating from the axis; a first spiral thread formed on the non-tapered portion of the shank and having thread turns, each of which has two diametrically disposed points that cooperatively define a diametrical line inclined at a first thread angle with respect to the radial plane; and two second spiral threads formed on the tapered end portion of the shank and twisted in opposite directions. Each of the second spiral threads has thread turns, each of which has two diametrically disposed points that cooperatively define a diametrical line inclined at a second thread angle with respect to the radial plane. The second thread angle is larger than the first thread angle.

### BACKGROUND OF THE INVENTION

1. Field of the Invention

This invention relates to a multiple-thread screw, more particularly to a multiple-thread screw having a first spiral thread defining a first thread angle and a second spiral thread defining a second thread angle larger than the first thread angle.

2. Description of the Related Art

FIG. 1 illustrates a conventional screw 2 for penetrating into a wooden workpiece 20. The screw 2 includes a head 21, a shank 22 extending from the head 21 and having a non-tapered portion 221 and a tapered end portion 222, a spiral thread 23 formed on the non-tapered portion 221 of the shank 22, and a lead blade unit 24 formed on the tapered end portion 222 of the shank 22. The conventional screw 2 is disadvantageous in that the shavings resulting from penetration of the screw 2 into the wooden workpiece 20 cannot be efficiently expelled out of the clearance between the screw 2 and the wooden workpiece 20, thereby resulting in cracking of the wooden workpiece 20.

### SUMMARY OF THE INVENTION

Therefore, the object of the present invention is to provide a multiple-thread screw that can overcome the aforesaid drawback of the prior art.

According to this invention, there is provided a multiple-thread screw that comprises: a shank having a tapered end portion and a non-tapered portion extending from the tapered end portion, the shank defining an axis and a radial plane radiating from the axis; a first thread unit including at least one first spiral thread formed on the non-tapered portion of the shank and having thread turns, each of which has two diametrically disposed points that cooperatively define a diametrical line inclined at a first thread angle with respect to the radial plane; and a second thread unit having a double-twist structure that includes two second spiral threads formed on the tapered end portion of the shank and twisted in opposite directions. Each of the second spiral threads has thread turns, each of which has two diametrically disposed points that cooperatively define a diametrical line inclined at a second thread angle with respect to the radial plane. The second thread angle is larger than the first thread angle.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is a partly sectional view of a conventional screw for penetrating into a wooden workpiece;

FIG. 2 is a perspective view of the first preferred embodiment of a multiple-thread screw according to this invention;

FIG. 3 is a fragmentary sectional view of the first preferred embodiment;

FIG. 4 is an enlarged view of a tapered end portion of a shank of the multiple-thread screw of the first preferred embodiment;

FIG. 5 is a fragmentary perspective view to illustrate how the first preferred embodiment penetrates into a wooden workpiece;

FIG. 6 is a perspective view of the second preferred embodiment of the multiple-thread screw of the second preferred embodiment according to this invention; and

FIG. 7 is a fragmentary sectional view of the second preferred embodiment.

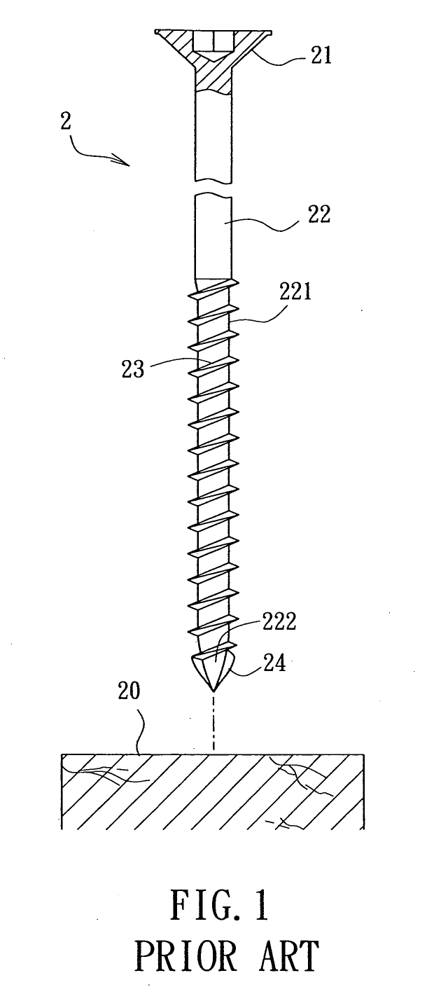

### DETAILED DESCRIPTION OF THE PREFERRED EMBODIMENTS

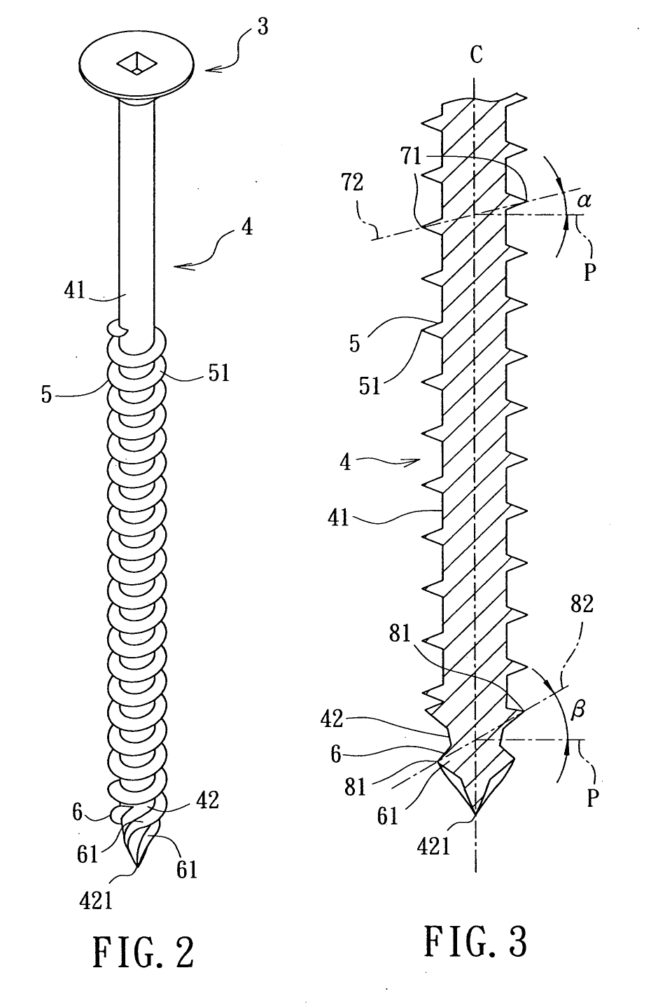

FIGS. 2 to 4 illustrate the first preferred embodiment of a wooden multiple-thread screw according to this invention. The multiple-thread screw includes: a head 3; a shank 4 extending from the head 3 and having a tapered end portion 42 and a non-tapered portion 41 extending from the tapered end portion 42, the shank 4 defining an axis (C) and a radial plane (P) radiating from the axis (C); a first thread unit 5 including at least one first spiral thread 51 formed on the non-tapered portion 41 of the shank 4 and having thread turns, each of which has two diametrically disposed points 71 that cooperatively define a diametrical line 72 inclined at a first thread angle a with respect to the radial plane (P); and a second thread unit 6 having a double-twist structure that includes two second spiral threads 61 formed on the tapered end portion 42 of the shank 4 and twisted in opposite directions. Each of the second spiral threads 61 has thread turns, each of which has two diametrically disposed points 81 that cooperatively define a diametrical line 82 inclined at a second thread angle β with respect to the radial plane (P). The second thread angle β is larger than the first thread angle α.

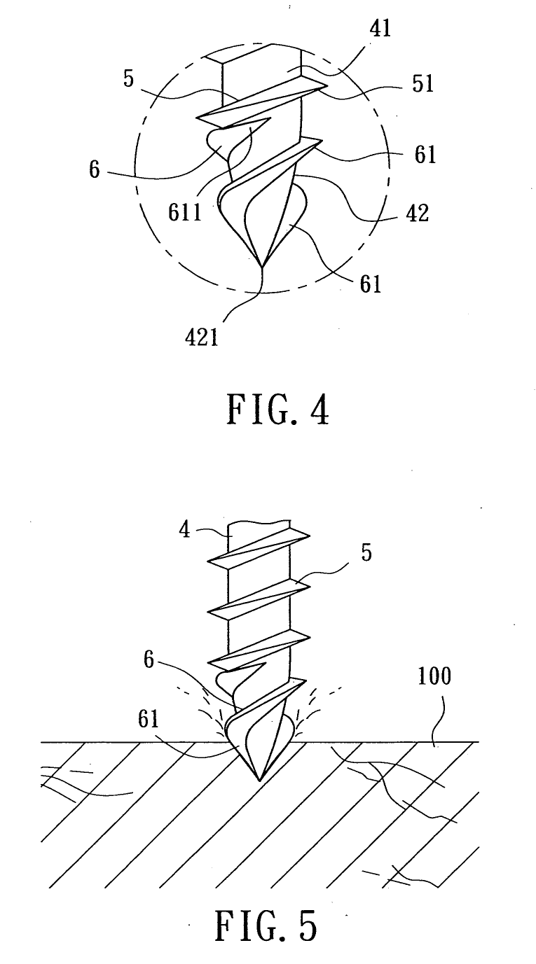

In this embodiment, the first spiral thread 51 has a lower end. The tapered end portion 42 of the shank 4 has a tip 421. One of the second spiral threads 61 has an upper end connected to the lower end of the first spiral thread 51, and a lower end extending to the tip 421 of the tapered end portion 42 of the shank 4. The other of the second spiral threads 61 has an upper end 611 disposed adjacent to a lower endmost one of the thread turns of the first spiral thread 51 (see FIG. 4), and a lower end extending to the tip 421 of the tapered end portion 42 of the shank 4.

FIG. 5 illustrates how the multiple-thread screw of the first preferred embodiment penetrates into a wooden workpiece 100.

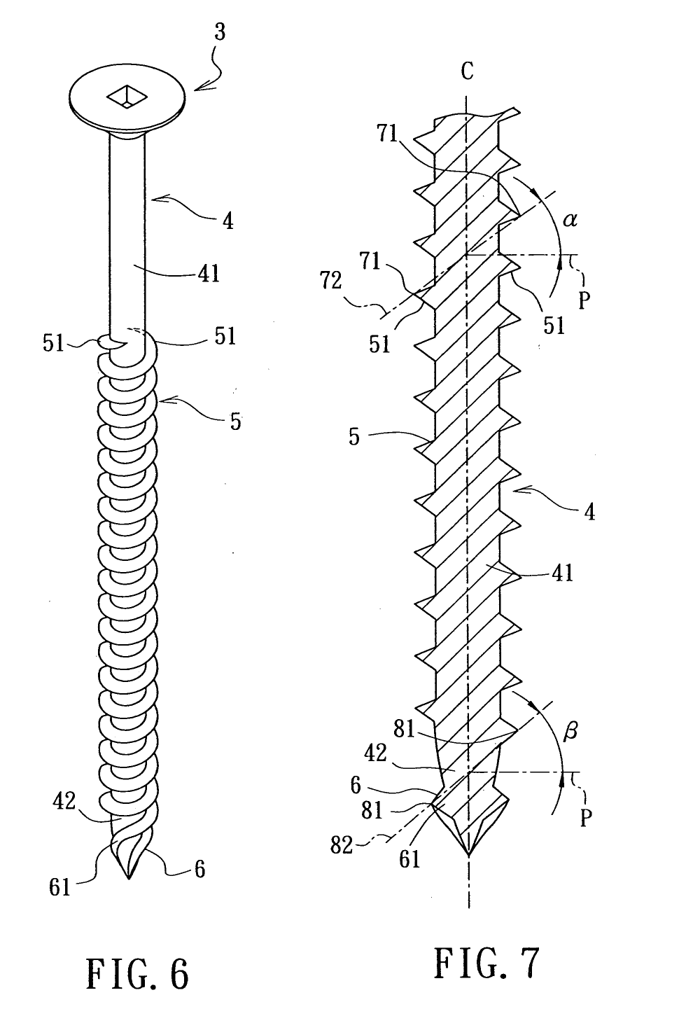

FIGS. 6 and 7 illustrate the second preferred embodiment of the multiple-thread screw according to this invention. The multiple-thread screw of this embodiment differs from the previous embodiment in that the first thread unit 5 has a double-twist structure that includes two first spiral threads 51 which are twisted in opposite directions.

By having the second thread angle β defined by the second spiral thread 61 larger than the first thread angle α defined by the first spiral thread 51, the shavings resulting from penetration of the multiple-thread screw into the wooden workpiece 100 can be efficiently expelled out of the clearance between the multiple-thread screw and the wooden workpiece 100, thereby eliminating the aforesaid drawback associated with the prior art.

While the present invention has been described in connection with what is considered the most practical and preferred embodiments, it is understood that this invention is not limited to the disclosed embodiments but is intended to cover various arrangements included within the spirit and scope of the broadest interpretation and equivalent arrangements.

What is claimed is:

1. A multiple-thread screw comprising:
a shank having a tapered end portion and a non-tapered portion extending from said tapered end portion, said shank defining an axis and a radial plane radiating from said axis;
a first thread unit including at least one first spiral thread formed on said non-tapered portion of said shank and having thread turns, each of which has two diametrically disposed points that cooperatively define a diametrical line inclined at a first thread angle with respect to said radial plane; and
a second thread unit having a double-twist structure that includes two second spiral threads formed on said tapered end portion of said shank and twisted in opposite directions, each of said second spiral threads having thread turns, each of which has two diametrically disposed points that cooperatively define a diametrical line inclined at a second thread angle with respect to said radial plane;
wherein said second thread angle is larger than said first thread angle.

2. The multiple-thread screw of claim 1, wherein said first spiral thread has a lower end, said tapered end portion of said shank having a tip, one of said second spiral threads having an upper end connected to said lower end of said first spiral thread, and a lower end extending to said tip of said tapered end portion of said shank, the other of said second spiral threads having an upper end disposed adjacent to a lower endmost one of said thread turns of said first spiral thread, and a lower end extending to said tip of said tapered end portion of said shank.

3. The multiple-thread screw of claim 1, wherein said first thread unit has a double-twist structure that includes two of said first spiral threads which are twisted in opposite directions.
